(19) United States
(12) Patent Application Publication
(10) Pub. No.: US 2021/0289133 A1
(43) Pub. Date: Sep. 16, 2021

(54) METHOD AND SYSTEM OF CONTROLLING VIDEO PLAY SPEED, CONTROL TERMINAL AND MOBILE PLATFORM

(71) Applicant: SZ DJI TECHNOLOGY CO., LTD., Shenzhen (CN)

(72) Inventor: Yang LI, Shenzhen (CN)

(73) Assignee: SZ DJI TECHNOLOGY CO., LTD., Shenzhen (CN)

(21) Appl. No.: 17/121,745

(22) Filed: Dec. 14, 2020

Related U.S. Application Data
(63) Continuation of application No. PCT/CN2018/097095, filed on Jul. 25, 2018.

(51) Int. Cl. H04N 5/232; G05D 1/00; B64D 47/08; B64C 39/02

(52) U.S. Cl. CPC H04N 5/23232; G05D 1/0016; B64C 2201/127; B64C 39/024; B64D 47/08

(57) ABSTRACT

The present disclosure provides a method and a system of controlling a video play speed, a control terminal and a mobile platform. The method includes: detecting, by a control terminal, an operation of controlling a video play speed, determining a video play speed as a first frame rate according to the operation of controlling a video play speed, then sending, to an unmanned aerial vehicle, a video capturing instruction, controlling, by the unmanned aerial vehicle, a photographing device of the unmanned aerial vehicle to capture images at a preset frame rate, and generating a video with an accelerated play speed or a decelerated play speed based on the first frame rate. The unmanned aerial vehicle may generate a video with a variable play speed without post-processing the video after generating the video, thereby improving the efficiency of adjusting the video play speed and facilitating operations.

### RELATED DISCLOSURES

This application is a continuation disclosure of PCT disclosure No. PCT/CN2018/097095, filed on Jul. 25, 2018, and the content of which is incorporated herein by reference in its entirety.

### TECHNICAL FIELD

The present disclosure relates to the technical field of image processing, and in particular to a method and a system of controlling a video play speed, a control terminal and a mobile platform.

### BACKGROUND

When a continuous image change exceeds 24 frames per second, according to the principle of persistence of vision, naked eyes cannot distinguish a single frame of static image, which looks like a smooth and continuous visual effect. Such images are called a video. A video play speed may be expressed in frame rate (fps), which refers to the number of frames of images that can be displayed per second. A video capture speed may also be expressed in frame rate, which refers to the number of frames of images that can be collected per second. Currently a capture speed of a video captured by an imaging device is typically 30 fps, and generally the play speed of the video is also the same as the capture speed of the video. If a user wants to adjust the video play speed, firstly the user uses the imaging device to capture a video at a video capture speed of 30 fps, and then increases the number of frames of images displayed per second by reducing the display time of a single frame of image to accelerate the video display speed, or, reduces the number of frames of images displayed per second by increasing the display time of a single frame of image to decelerate the video play speed. However, in the existing methods of adjusting the video play speed, the video play speed can only be adjusted after the video is collected and artificially post-processed, resulting in low efficiency of adjusting the video play speed.

### SUMMARY

Exemplary embodiments of the present disclosure provide a method and a system of controlling a video play speed, a control terminal and a mobile platform, which are used for generating a video with an accelerated play speed or a decelerated play speed during a shooting process, without the need for post-processing to change the play speed after the video is generated, thereby improving the efficiency of adjusting the video play speed and facilitating operations.

In a first aspect, the present disclosure provides a method of controlling a video play speed by a control terminal, including detecting an operation of controlling a video play speed; determining, according to the operation of controlling a video play speed, a video play speed as a first frame rate higher than or lower than a preset frame rate; and sending, to a mobile platform, a video capturing instruction to instruct the mobile platform to capture images based on the preset frame rate and generate a video with an accelerated play speed or a decelerated play speed based on the first frame rate.

In a second aspect, the present disclosure provides a method of controlling a video play speed by a mobile platform, includes receiving a video capturing instruction sent by a control terminal of the mobile platform to instruct the mobile platform to capture images based on a preset frame rate and generate a video based on a first frame rate lower than or higher than the preset frame rate; and controlling a photographing device of the mobile platform to capture images at the preset frame rate and generate a video with an accelerated play speed or a decelerated play speed based on the first frame rate.

In a third aspect, the present disclosure provides a control terminal, including an interactive device to detect an operation of controlling a video play speed; a first processor to determine, according to the operation of controlling a video play speed, a video play speed as a first frame rate, wherein the first frame rate is higher than or lower than a preset frame rate; and a first communication device to send a video capturing instruction to a mobile terminal to instruct the mobile platform to capture images based on the preset frame rate and generate a video with an accelerated play speed or a decelerated play speed based on the first frame rate.

Exemplary embodiments of the present disclosure provide a method and a system of controlling a video play speed, a control terminal and a mobile platform. An operation of controlling a video play speed may be detected by a control terminal, which then determines the video play speed as the first frame rate based on the operation of controlling a video play speed, sends the video capturing instruction to the unmanned aerial vehicle, and controls, by the unmanned aerial vehicle, the photographing device of the unmanned aerial vehicle to capture images at the preset frame rate and generates a video with an accelerated play speed or a decelerated play speed according to the first fame rate. During the process of capturing images by the unmanned aerial vehicle in this exemplary embodiment, the unmanned aerial vehicle is controlled to generate a video with a variable play speed without changing the play speed through post-processing after the video is generated, thereby improving the efficiency of adjusting the video play speed and facilitating operations in this exemplary embodiment.

### BRIEF DESCRIPTION OF THE DRAWINGS

In order to describe the technical solutions of exemplary embodiments of the present disclosure or more clearly, the drawings used in the descriptions of some exemplary embodiments or will be introduced briefly. It is apparent that the following figures are merely some of the embodiments of the present disclosure, and those having ordinary skills in the art, without making inventive efforts, may further obtain other figures according to these figures.

FIG. 1 is a schematic architecture diagram of an unmanned aerial vehicle according to some exemplary embodiments of the present disclosure;

FIG. 2 is a flow chart of a method of controlling a video play speed according to some exemplary embodiments of the present disclosure;

FIG. 3 is a schematic diagram of determining a play speed of a video according to some exemplary embodiments of the present disclosure;

FIG. 4 is a schematic diagram of determining a play speed of a video according to a some exemplary embodiments of the present disclosure;

FIG. 5 is a schematic structural diagram of a control terminal according to some exemplary embodiments of the present disclosure;

FIG. 6 is a schematic structural diagram of a mobile terminal according to some exemplary embodiments of the present disclosure;

FIG. 7 is a schematic structural diagram of a system of controlling a video play speed according to some exemplary embodiments of the present disclosure.

### DETAILED DESCRIPTION

In order to describe the object, technical solutions and advantages of the embodiments of the present disclosure more clearly, the technical solutions of some exemplary embodiments of the present disclosure will be described clearly and comprehensively with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that, when a component is “fixed to” another component, it may be a component directly provided on another component or there may be an intermediate component therebetween. When one component is regarded as being “connected to” another component, it may be directly connected to another component or there may be an intermediate component therebetween.

Unless otherwise defined, all the technologies and terms used in the context have the same meaning as those of ordinary skills in the art generally understand. The terms to be used in the description of the present disclosure merely serve to describe some specific embodiments rather than limiting the present disclosure. The term “and/or” used in the context includes any one or more associated items listed or all the combinations thereof.

Some of the exemplary embodiments of the present disclosure will be described in detail with reference to the drawings. The following exemplary embodiments and features therein may be combined if no conflict is caused.

Some exemplary embodiments of the present disclosure provide a method and a system of controlling a video play speed, a control terminal, and a mobile platform. The mobile platform may be, for example, an unmanned aerial vehicle, an unmanned ship, an unmanned car, a robot, and the like. The unmanned aerial vehicle may be, for example, a rotorcraft such as a multi-rotor aircraft propelled by a plurality of propulsion devices by air, and the embodiments of the present disclosure are not limited thereto.

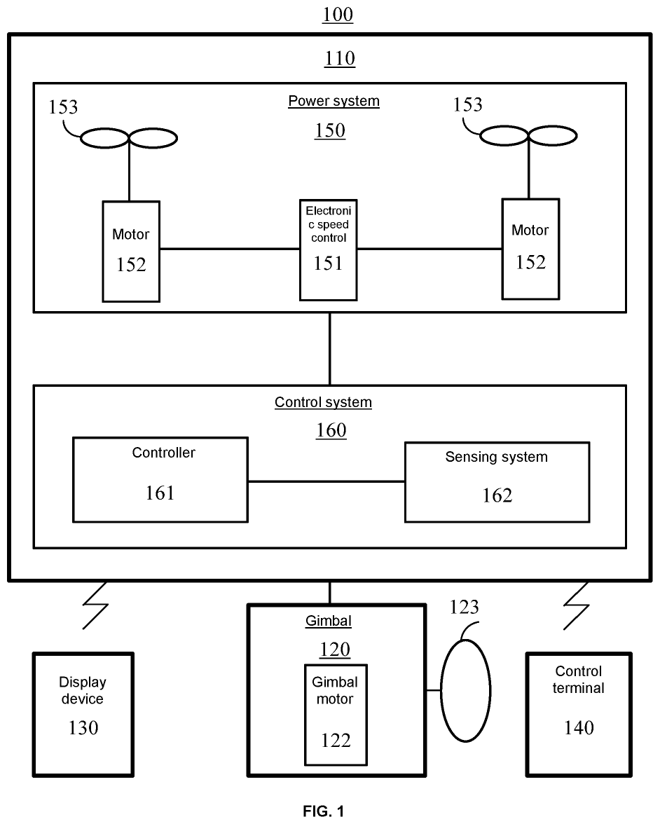

FIG. 1 is a schematic architecture diagram of an unmanned aerial vehicle system according to some exemplary embodiments of the present disclosure. In this exemplary embodiment, a rotor unmanned aerial vehicle is taken as an example for illustrative purposes.

An unmanned aerial vehicle system 100 may include an unmanned aerial vehicle 110, a display device 130 and a control terminal 140. In this exemplary embodiment, the unmanned aerial vehicle 110 is described with an unmanned aircraft as an example, which may include a power system 150, a control system 160, a frame, and a gimbal 120 arranged on the frame. The unmanned aerial vehicle 110 may communicate with the control terminal 140 and the display device 130 wirelessly. In other exemplary embodiments, the unmanned aerial vehicle may also be an unmanned vehicle or an unmanned ship.

The frame may include a body and a landing gear. The body may include a central frame and one or more arms connected to the central frame, where the one or more arms extend radially from the central frame. The tripod is connected with the body, and functions to support when the unmanned aerial vehicle 110 is landing.

The power system 150 may include one or more electronic speed controls (called ESCs for short) 151, one or more propellers 153, and one or more motors 152 corresponding to the one or more propellers 153. The motors 152 are connected between the ESCs 151 and the propellers 153, and the motors 152 and the propellers 153 are provided on the arms of the unmanned aerial vehicle 110. The ESCs 151 are used to receive driving signals generated by the control system 160 and provide driving current to the motors 152 according to the driving signals to control rotating speeds of the motors 152. It should be noted that, one of the ESCs 151 may correspond to a plurality of motors, or a plurality of ESCs 151 may correspond to one of the motors 152. The motors 152 are used to drive the propellers to rotate, thereby providing a power for the flight of the unmanned aerial vehicle 110, where the power enables the unmanned aerial vehicle 110 to realize movements of one or more degrees of freedom. In certain exemplary embodiments, the unmanned aerial vehicle 110 may rotate about one or more rotation axes. For example, the rotation axes may include a roll axis, a yaw axis, and a pitch axis. It should be understood that the motors 152 may be either DC motors or AC motors. In addition, the motors 152 may be either brushless motors or brushed motors.

The control system 160 may include a controller 161 and a sensing system 162. The sensing system 162 is used to measure attitude information of the unmanned aerial vehicle, i.e., spatial position information and state information of the unmanned aerial vehicle 110, such as a three-dimensional position, a three-dimensional angle, a three-dimensional speed, a three-dimensional acceleration, and a three-dimensional angular speed. The sensing system 162 may include, for example, at least one of sensors, such as a gyroscope, an ultrasonic sensor, an electronic compass, an inertial measurement unit (IMU), a vision sensor, a global navigation satellite system and a barometer. For example, the global navigation satellite system may be a global positioning system (GPS). The controller 161 is used to control the flight or operation of the unmanned aerial vehicle 110. For example, the controller 161 may control the flight or operation of the unmanned aerial vehicle 110 according to the attitude information measured by the sensing system 162. It should be understood that the controller 161 may control the unmanned aerial vehicle 110 according to pre-programmed program instructions, or control the unmanned aerial vehicle 110 by responding to one or more control instructions from the control terminal 140.

The gimbal 120 may include a gimbal motor 122. The gimbal is used to carry a photographing device 123. The controller 161 may control movements of the gimbal 120 through the gimbal motor 122. In some examples, the gimbal 120 may further include a gimbal controller for controlling movements of the gimbal 120 by controlling the gimbal motor 122. It should be understood that the gimbal 120 may be independent from the unmanned aerial vehicle 110, or may be a part of the unmanned aerial vehicle 110, and the gimbal motor 122 may be either a DC motor or an AC motor. In addition, the gimbal motor 122 may be either a brushless motor or a brushed motor. It should be further understood that the gimbal may be positioned on the top of the unmanned aerial vehicle, or at the bottom thereof.

The photographing device 123 may be a device for capturing images, such as a camera or a video camera, and may communicate with a flight controller and capture images under the control of the flight controller. The photographing device 123 of this exemplary embodiment at least includes a photosensitive element, which may be, e.g., a complementary metal oxide semiconductor (CMOS) sensor or a charge-coupled device (CCD) sensor. It should be understood that the photographing device 123 may also be directly fixed to the unmanned aerial vehicle 110, such that the gimbal 120 may be omitted.

The display device 130 may be arranged at the ground end, may communicate with the unmanned aerial vehicle 110 wirelessly, and may be used to display the attitude information of the unmanned aerial vehicle 110. In addition, images captured by an imaging device may also be displayed on the display device 130. It should be understood that the display device 130 may be an independent device or integrated to the control terminal 140.

The control terminal 140 may be arranged at the ground end of the unmanned aerial vehicle system 100, and may communicate with the unmanned aerial vehicle 110 wirelessly for remote control of the unmanned aerial vehicle 110.

In addition, a speaker (not shown in the figures) may be further provided on the unmanned aerial vehicle 110. The speaker is used to play audio files, and may be directly fixed to the unmanned aerial vehicle 110 or carried by the gimbal 120.

It should be understood that the terms of the components of the unmanned aerial vehicle system merely serve for identification purposes and should not be understood as limiting the embodiments of the present disclosure. By taking the example in which the mobile platform is an unmanned aerial vehicle, the solution of the present disclosure will be described below.

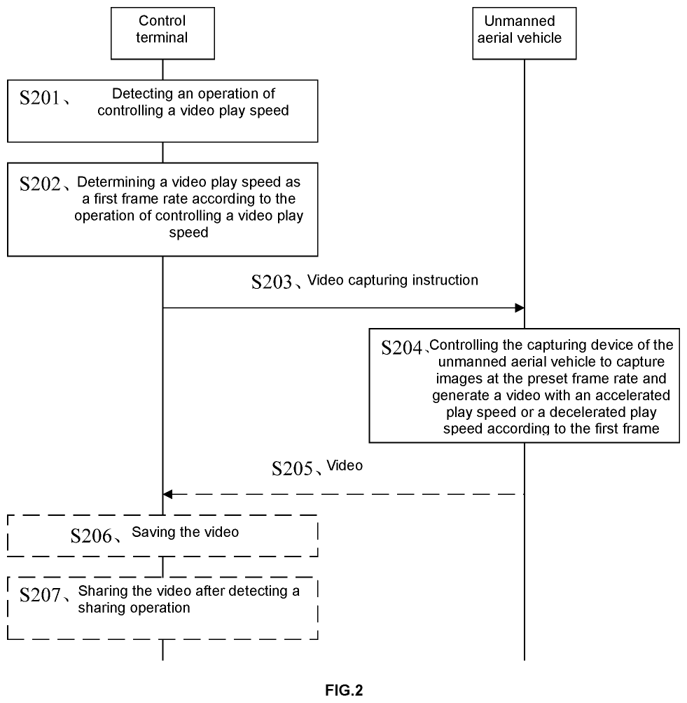

FIG. 2 is a flowchart of a method of controlling a video play speed according to some exemplary embodiments of the present disclosure. As shown in FIG. 2, the method in this exemplary embodiment may include:

S201. Detect, by a control terminal, an operation of controlling a video play speed.

In this exemplary embodiment, the control terminal may be a control terminal of the unmanned aerial vehicle, and the control terminal may detect a user's operation of controlling a video play speed. The control terminal includes one or more of a remote control, a smart phone, a tablet computer, a laptop computer, a wearable device, and a remote control device with a touch display screen, which will not be discussed herein. Detecting, by a control terminal, an operation of controlling a video play speed may be, e.g., detecting, by the control terminal, the operation of controlling a video play speed through an interactive device. The interactive device may be an important part of the control terminal, which is an interface for interacting with the user, and the user may control the unmanned aerial vehicle by operating the interactive device. When the user wants to control the unmanned aerial vehicle, the user may operate the interactive device of the control terminal, by means of which the control terminal detects the user's operation. In this exemplary embodiment, when the user wants to control the play speed of the video captured by the unmanned aerial vehicle, the user may perform the operation of controlling a video play speed on the interactive device, and the interactive device can detect the operation of controlling a video play speed. Thus the control terminal may detect the user's operation of controlling a video play speed by means of the interactive device; the interactive device may be, e.g., one or more of a touch display screen, a keyboard, a joystick, and a dial wheel of the control terminal. At the same time, a touch control screen may also display all the parameters of the flight of the unmanned aerial vehicle, and may display pictures captured by the unmanned aerial vehicle.

S202. Determine, by the control terminal, a video play speed as a first frame rate based on the operation of controlling a video play speed.

In this exemplary embodiment, after detecting the operation of controlling a video play speed, the control terminal determines the video play speed based on the operation of controlling a video play speed. The video play speed is, e.g., the first frame rate, where the first frame rate may be higher than a preset frame rate, or the first frame rate may be lower than the preset frame rate. If the first frame rate is higher than the preset frame rate, it indicates that the user needs to accelerate the video play speed. If the first frame rate is lower than the preset frame rate, it indicates that the user needs to decelerate the video play speed. In some examples, the first frame rate may be equal to the preset frame rate, and if the first frame rate is equal to the preset frame rate, it indicates that the user does not want to adjust the video play speed. The specific implementation process is similar to that of the existing technology, and will not be discussed herein.

The step of determining the video play speed will be exemplified below.

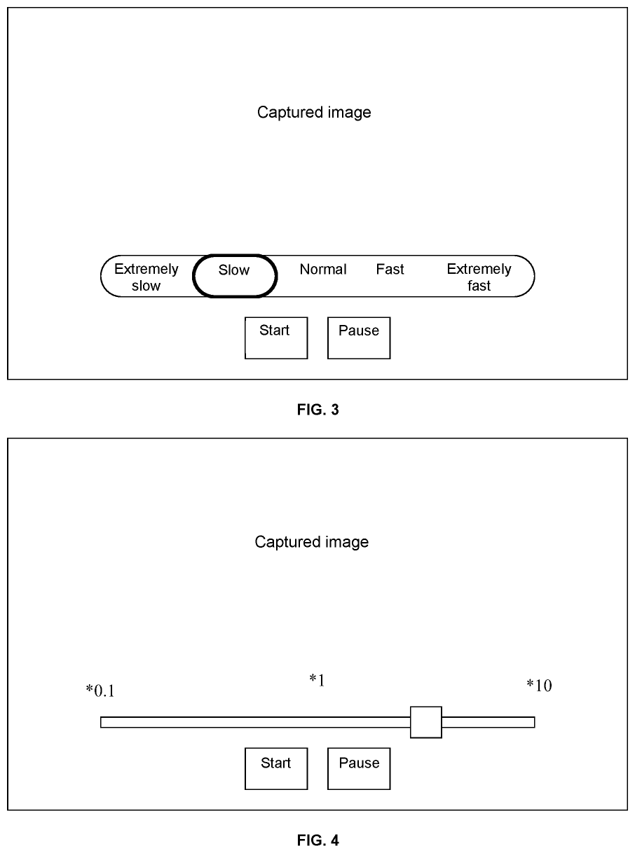

FIG. 3 is a schematic diagram of determining the video play speed according to some exemplary embodiments of the present disclosure. As shown in FIG. 3, the video play speed may be adjusted to be one of the following 5 types, namely, extremely slow, slow, normal, fast, and extremely fast. When the user performs a contact operation on the icon “normal”, it indicates that there is no need for adjusting the video play speed, and the video play speed is equal to a frame rate corresponding to “normal” (i.e., the preset frame rate). When the user performs a contact operation on the icon “slow”, it indicates that there is a need for adjusting the video play speed, and the video play speed is a frame rate corresponding to “slow”. When the user performs a contact operation on the icon “extremely slow”, it indicates that there is a need for adjusting the video play speed, and the video play speed is a frame rate corresponding to “extremely slow”. When the user performs a contact operation on the icon “fast”, it indicates that there is a need for adjusting the video play speed, and the video play speed is a frame rate corresponding to “fast”. When the user performs a contact operation on the icon “extremely fast”, it indicates that there is a need for adjusting the video play speed, and the video play speed is a frame rate corresponding to “extremely fast”. As shown in FIG. 3, the user currently selects the icon “slow”, and the video play speed (i.e., the first frame rate) is a frame rate corresponding to “slow. The frame rate corresponding to “extremely slow”<the frame rate corresponding to “slow”<the preset frame rate<the frame rate corresponding to “fast”<the frame rate corresponding to “extremely fast”. Specific values of the frame rate corresponding to “extremely slow”, the frame rate corresponding to “slow”, the frame rate corresponding to “fast”, and the frame rate corresponding to “extremely fast” may be determined according to actual application situations, and will not be limited herein.

FIG. 4 is a schematic diagram of determining a video play speed according to another embodiment of the present disclosure. As shown in FIG. 4, the video play speed may be adjusted between a preset frame rate*0.1 and a preset frame rate*10, which will not be limited in this exemplary embodiment. For example, the video play speed may also be adjusted between a preset frame rate*0.05 and a preset frame rate*20. When the user wants a specific video play speed, the user may adjust the position of a play speed adjustment block in a play speed adjustment progress bar. When the play speed adjustment block is positioned in the position corresponding to *1, it indicates that the user does not need to adjust the video play speed, thus the video play speed is equal to the preset frame rate. When the user wants to accelerate the video play speed, the user may slide the play speed adjustment block in the play speed adjustment progress bar to the right of the position corresponding to *1, the video play speed is the preset frame rate * a first value, the first value is greater than 1 and smaller than or equal to 10, and the specific value of the first value is associated with a position of the play speed adjustment block on the right side of the position corresponding to *1. When the user wants to decelerate the video play speed, the user may slide the play speed adjustment block in the play speed adjustment progress bar to the left of the position corresponding to *1, the video play speed is the preset frame rate *a second value, the second value is greater than or equal to 0.1 and smaller than 1, and the value of the second value is associated with a position of the play speed adjustment block on the left of the position corresponding to *1. As shown in FIG. 4, the user adjusts the play speed adjustment block to a middle position between the position corresponding to *1 and the position corresponding to *10, and the video play speed (i.e., the first frame rate) is, e.g., the preset frame rate*5.

It should be noted that this exemplary embodiment is not limited to what are shown in FIGS. 3 and 4.

S203. Send, by the control terminal, a video capturing instruction to the unmanned aerial vehicle, and correspondingly, receive, by the unmanned aerial vehicle, the video capturing instruction sent by the control terminal.

In this exemplary embodiment, after determining the video play speed as the first frame rate, the control terminal sends, to the unmanned aerial vehicle, the video capturing instruction to instruct the unmanned aerial vehicle to capture images according to the preset frame rate, and generate a video with an accelerated play speed or a decelerated play speed according to the first frame rate. If the first frame rate is higher than the preset frame rate, the video capturing instruction instructs the unmanned aerial vehicle to generate a video with an accelerated play speed according to the first frame rate. If the first frame rate is lower than the preset frame rate, the video capturing instruction instructs the unmanned aerial vehicle to generate a video with a decelerated play speed according to the first frame rate.

S204. Control, by the unmanned aerial vehicle, the photographing device of the unmanned aerial vehicle to capture images at the preset frame rate and generate a video with an accelerated play speed or a decelerated play speed according to the first frame rate.

In this exemplary embodiment, after receiving the video capturing instruction sent by the control terminal, the unmanned aerial vehicle controls the photographing device of the unmanned aerial vehicle to capture images at the preset frame rate according to the video capturing instruction, and generates a video with an accelerated play speed or a decelerated play speed according to the first frame rate. It needs to be noted that no matter whether the first frame rate is higher than or lower than the preset frame rate, the photographing device of the unmanned aerial vehicle in this exemplary embodiment still captures images at the preset frame rate. When generating a video, the unmanned aerial vehicle will generate a video with an accelerated play speed or a decelerated play speed. When the first frame rate is higher than the preset frame rate, the unmanned aerial vehicle will generate a video with an accelerated play speed; while when the first frame rate is lower than the preset frame rate, the unmanned aerial vehicle will generate a video with a decelerated play speed.

The method of controlling a video play speed provided in this exemplary embodiment detects the operation of controlling a video play speed by the control terminal, determines the video play speed as the first frame rate based on the operation of controlling a video play speed, sends the video capturing instruction to the unmanned aerial vehicle, and controls, by the unmanned aerial vehicle, the photographing device of the unmanned aerial vehicle to capture images at the preset frame rate and generates a video with an accelerated play speed or a decelerated play speed according to the first fame rate. During the process of capturing images by the unmanned aerial vehicle in this exemplary embodiment, the unmanned aerial vehicle is controlled to generate a video with a variable play speed without changing the play speed through post-processing after the video is generated, thereby improving the efficiency of adjusting the video play speed and facilitating operations in this exemplary embodiment.

In some examples, after generating a video with an accelerated play speed or a decelerated play speed, the unmanned aerial vehicle may send the video to the control terminal or to other devices (e.g., a cloud server), or the unmanned aerial vehicle may save the generated video. That unmanned aerial vehicle sends the video to the control terminal will be taken as an example below. That is, this exemplary embodiment may further include:

S205. Send, by the unmanned aerial vehicle, the video to the control terminal, and correspondingly, receive, by the control terminal, the video sent by the unmanned aerial vehicle.

In this exemplary embodiment, the unmanned aerial vehicle sends the generated video with an accelerated or decelerated play speed to the control terminal, and the control terminal receives the video with an accelerated or decelerated play speed sent by the unmanned aerial vehicle.

S206. Save the video by the control terminal.

In this exemplary embodiment, the control terminal saves the video after receiving the video sent by the unmanned aerial vehicle.

S207. Share the video after the control terminal detects a sharing operation.

In this exemplary embodiment, after the control terminal receives the video sent by the unmanned aerial vehicle, the user may share the video. In such a case, the user may perform the sharing operation on the interactive device. The control terminal may detect the sharing operation through the interactive device, and share the video after detecting the sharing operation through the interactive device. For example, the control terminal may publish the video on a network (e.g., social networking sites, or social applications (APPs)).

Therefore, by adopting the solution of this exemplary embodiment to change the video play speed, a video with a variable play speed may be quickly obtained, so that the video may be then shared quickly and easily.

It should be noted that S207 may be executed after S205 is executed, and execution of S207 may not be limited by S206.

The step of the unmanned aerial vehicle generating a video with an accelerated play speed or a decelerated play speed according to the first frame rate will be described below.

If the first frame rate is higher than the preset frame rate, the unmanned aerial vehicle generates a video with an accelerated play speed. In other words, the unmanned aerial vehicle captures images at the preset frame rate; assuming the preset frame rate is 30 frames per second, that is, the unmanned aerial vehicle captures 30 frames of images per second; in such a case, the unmanned aerial vehicle, based on the first frame rate, performs frame-extraction processing on the images captured at the preset frame rate, and generates a video with an accelerated play speed from the images frame-extraction processed.

In a possible implementation manner, the unmanned aerial vehicle determines the size of frame-extraction interval according to the first frame rate and the preset frame rate, the size of frame-extraction interval representing extracting T frames at an interval of N frames, where N and T are integers higher than or equal to 1, and thus the unmanned aerial vehicle frame-extraction processes the images captured at the preset frame rate according to the size of frame-extraction interval. The preset frame rate is, e.g., 30 frames per second, and the first frame rate is, e.g., 150 frames per second. For the video play speed of 150 frames per second, it indicates that 150 frames of images captured by the unmanned aerial vehicle should be played per second. Therefore, in this exemplary embodiment, 150 frames of images captured by the unmanned aerial vehicle within 5 seconds will be frame-extraction processed, the unmanned aerial vehicle obtains the first frame rate/the preset frame rate according to the preset frame rate of 30 frames per second and the first frame rate of 150 frames per second, and then determines, based on the value of the first frame rate/the preset frame rate, (T+N)/N, i.e., 150/30=(4+1)/1, i.e., determines extracting 4 frames at an interval of 1 frame, then frame-extraction processes the images captured by the unmanned aerial vehicle at 30 frames per second with the mode of extracting 4 frames at an interval of a frame (for example, the unmanned aerial vehicle obtains the first to fifth frames of images, it removes the second to the fifth frames of images from the first to the fifth frame and retains the first frame of image), so as to process the 150 frames of images captured every 5 seconds into 30 frames of images. Assuming that the unmanned aerial vehicle captures images for one minute (i.e., the unmanned aerial vehicle collects 1,800 frames of images), 360 frames of images are obtained after the images are frame-extraction processed, i.e., a video lasting for 12 seconds is generated. In other words, a video having 30 frames of images is played per second. In some examples, after the control terminal receives the video sent by the unmanned aerial vehicle, the control terminal detects a play operation and plays the video. During the process of playing the video, the control terminal actually plays 30 frames per second, which lasts for 12 seconds. In this process is equivalent to that the images captured by the unmanned aerial vehicle for 1 minute are actually played for a total of 12 seconds, and thus it seems that the video play speed has been accelerated.

In this case, the first frame rate is higher than the preset frame rate. The first frame rate/the preset frame rate is equal to (T+N)/N, and thus when the first frame rate/the preset frame rate is higher than 2, T is greater than N, when the first frame rate/the preset frame rate is equal to 2, T is equal to N, and when the first frame rate/the preset frame rate is lower than 2, T is smaller than N.

If the first frame rate is lower than the preset frame rate, the unmanned aerial vehicle generates a video with a decelerated play speed.

In some embodiments, the unmanned aerial vehicle captures images at the preset frame rate, extracts M frames of images from the images captured at the preset frame rate according to the first frame rate, and then generates a video with an accelerated play speed or a decelerated play speed based on the M frames of images.

A possible implementation manner for the unmanned aerial vehicle to extract the M frames of images is as follows: the unmanned aerial vehicle determines the size of frame-extraction interval based on the first frame rate and the preset frame rate, the size of frame-extraction interval representing extracting K frames at an interval of Q frames, where Q and K are integers greater than or equal to 1 and Q is smaller than or equal to K, and then, the unmanned aerial vehicle extracts the M frames of images from the images captured at the preset frame rate with the mode of extracting K frames at an interval of Q frames of images.

The preset frame rate is, e.g., 30 frames per second, and the first frame rate is, e.g., 6 frames per second. For the video play speed of 6 frames per second, it indicates that 6 frames of images captured by the unmanned aerial vehicle are to be played per second. Therefore, in this exemplary embodiment, 30 frames of images captured by the unmanned aerial vehicle per second are frame-extraction processed, the unmanned aerial vehicle obtains the preset frame rate/the first frame rate according to the preset frame rate of 30 frames per second and the first frame rate of 6 frames per second, and then determines (Q+K)/K based on the value of the preset frame rate/the first frame rate, i.e., 30/6=(4+1)/1, i.e., determines extracting 1 frame at an interval of 4 frames, and then extracts 1 frame at an interval of 4 frames from the images captured at 30 frames per second (for example, the unmanned aerial vehicle obtains the first to the fifth frames of images, and extracts the fifth frame of image from the first to the fifth frames of images so as to obtain/retain the fifth frame of image) so as to extract 6 frames of images from the 30 frames of images captured per second. Assuming that the unmanned aerial vehicle has captured images for a total of 1 minute (that is, the unmanned aerial vehicle collects a total of 1,800 frames of images), 360 frames of images may be extracted from the 1,800 frames of images with the mode of extracting 1 frame at an interval of 4 frames. In another possible implementation manner, instead of extracting 1 frame at an interval of 4 frames, 360 frames of images may be randomly extracted at intervals from the 1,800 frames of images.

It is noted that the frame-extraction process herein is referred to a process of extracting a few frames out from multiple frames, which does not limit the sequent processing on the extracted frames, that is, the extracted frames may be either retained as the obtained frames, or may be removed, such that the remaining frames are the obtained frames.

In some other embodiments, during the process of capturing images at the preset frame rate by the photographing device of the unmanned aerial vehicle, the unmanned aerial vehicle controls the photographing device to capture M frames of images according to the first frame rate, and then generates a video with a decelerated play speed according to the M frames of images.

During the process of capturing images at the preset frame rate by the photographing device of the unmanned aerial vehicle, one possible implementation manner of controlling the photographing device to collect M frames of images according to the first frame rate is as follows: determining the number of collected frames based on the first frame rate and the preset frame rate, the number of collected frames representing collecting K frames at an interval of Q frames, where Q and K are integers greater than or equal to 1, and during the process of capturing images at the preset frame rate by the photographing device of the unmanned aerial vehicle, controlling the the photographing device to collect K frames of images at an interval of Q frames so as to obtain M frames of images.

The preset frame rate is, e.g., 30 frames per second, and the first frame rate is, e.g., 6 frames per second. For the video play speed of 6 frames per second, it indicates that 6 frames of images captured by the unmanned aerial vehicle are to be played per second. Therefore, the unmanned aerial vehicle may capture 30 frames of images per second, but only collect 6 frames of images without collecting the other 24 frames of images. The unmanned aerial vehicle obtains the preset frame rate/the first frame rate based on the preset frame rate of 30 frames per second and the first frame rate of 6 frames per second, and according to the value of the preset frame rate/the first frame rate, determines (Q+K)/K, i.e., 30/6=(4+1)/1, that is, determines to collect 1 frame at an interval of 4 frames, and then the unmanned aerial vehicle performs capturing at 30 frames per second and then obtains 1 frame at an interval of 4 frames (for example, the unmanned aerial vehicle captures the first to fifth frames of images; however, it does not collect the images when capturing the first to fourth frames but only collects the fifth frame of image when capturing the fifth frame), so as to collect 6 frames of images per second from the process of capturing 30 frames of images per second. Assuming that the unmanned aerial vehicle has captured images for a total of 1 minute (that is, the unmanned aerial vehicle has captured a total of 1,800 frames), the unmanned aerial vehicle may obtain 360 frames of images from the above 1,800 frames with the mode of collecting 1 frame at an interval of 4 frames. In another possible implementation manner, instead of collecting 1 frame at an interval of 4 frames, 360 frames of images may be randomly collected at intervals during the capturing process lasting for one minute.

In the above embodiments where the first frame rate is lower than the preset frame rate, the preset frame rate/the first frame rate is equal to (Q+K)/K, and thus, when the preset frame rate/the first frame rate is higher than 2, Q is greater than K; when the preset frame rate/the first frame rate is equal to 2, Q is equal to K; and when the preset frame rate/the first frame rate is lower than 2, Q is smaller than K.

In the above embodiments, a possible implementation manner of generating a video with a decelerated play speed based on the M frames of images obtained is as follows: copying and/or processing every K frames of images in the M frames of images into a Q+K frames of images, and generating a video with a decelerated play speed from the images copied and processed. Taking the mode of obtaining 1 frame at an interval of 3 frames in the above exemplary embodiment as an example, after capturing images for one minute, the unmanned aerial vehicle obtains a total of 360 frames of images which is equivalent to a video of 12 seconds, and then copies and processes the 360 frames of images into 1,800 frames of images (e.g., copies each frame of image four times to obtain five frames of images which are exactly the same), and generates a video of 1 minute based on the 1,800 frames of images. Thus the generated video is a video where 30 frames of images are played per second, and every five frames of images are the same frame of image, which is equivalent to playing the same frame of image at the time of playing every five frames of images. In some examples, after receiving the video sent by the unmanned aerial vehicle, the control terminal detects the play operation and plays the video. During the process of playing the video, the control terminal actually plays 30 frames per second, which lasts for 1 minute. This process is equivalent to playing, for 1 minute; all of the images captured by the unmanned aerial vehicle in 1 minute, but actually only a part of the images captured by the unmanned aerial vehicle are played. Hence, it seems that the video play speed is decelerated.

On the basis of the above exemplary embodiments, in some embodiments, the control terminal further detects an operation of starting capturing a video before sending the video capturing instruction to the unmanned aerial vehicle, and sends the video capturing instruction to the unmanned aerial vehicle when detecting the operation of starting capturing a video. Specifically, after the control terminal detects the operation of controlling a video play speed and then determines the video play speed as the first frame rate according to the operation of controlling a video play speed, the control terminal further detects the operation of starting capturing a video. When the user wants to control the unmanned aerial vehicle to generate a video according to the first frame rate, the user may perform the operation of starting capturing a video on the interactive device. For example, the control terminal may display the icon “Start” (as shown in FIGS. 3 and 4), and the user may perform a contact operation on the icon “Start”. Then, when detecting the operation of starting capturing a video, the control terminal sends a video capturing instruction to the unmanned aerial vehicle. In some examples, after the user clicks the icon “Start”, the icon “Start” may be changed to the icon “End”. When the user wants to end capturing, the user may perform a contact operation on the icon “End” to perform an operation of ending capturing to the control terminal, when detecting the operation of ending capturing, the control terminal sends an instruction of ending capturing to the unmanned aerial vehicle; after receiving the instruction of ending capturing, the unmanned aerial vehicle controls the photographing device to stop capturing images and then generates a complete video.

Based on the above exemplary embodiments, in some embodiments, the user may control the unmanned aerial vehicle to pause capturing at any time during the process of capturing by the unmanned aerial vehicle. Specifically, during the process of capturing images according to the preset frame rate by the photographing device of the unmanned aerial vehicle, the control terminal detects an operation of pausing capturing a video. When the user needs to control the unmanned aerial vehicle to pause capturing a video, the user may perform the operation of pausing capturing a video on the interactive device. For example, the control terminal may display the icon “Pause” (as shown in the figures) when the unmanned aerial vehicle is performing capturing, and the user may perform a contact operation on the icon “Pause” through the interactive device. Correspondingly, the control terminal may detect the operation of pausing capturing a video through the interactive device, and when detecting the operation of pausing capturing a video, it sends an instruction of pausing capturing a video to the unmanned aerial vehicle. Accordingly, the unmanned aerial vehicle receives the instruction of pausing capturing a video sent by the control terminal and controls the photographing device to pause capturing images according to the instruction of pausing capturing a video. In some examples, after the ion “Start” is changed to the icon “End”, when the user clicks the icon “Pause”, the icon “End” may be changed to the icon “Start” again.

In some examples, in this exemplary embodiment, after the unmanned aerial vehicle controls the photographing device to pause capturing images, the solutions of the above embodiments may be executed again. When the solutions of the above embodiments are executed again, the user may adjust the video play speed to a second frame rate which may not be equal to the first frame rate. In this way, after the unmanned aerial vehicle controls the photographing device to end capturing images, the generated video may include a plurality of segments of videos with an accelerated or decelerated play speed. For example, the foregoing segment of the generated video is a video with a decelerated play speed, the middle segment thereof is a video with a normal play speed, and the following segment thereof is a video with an accelerated play speed; or, the foregoing segment of the generated video is a video with an extremely slow play speed, the middle segment thereof is a video with a slow play speed, and the following segment thereof is a video with a normal play speed. It should be noted that this exemplary embodiment is not limited to the examples mentioned. To sum up, by means of the above solutions, the generated video is no longer limited to a video with an accelerated play speed or a decelerated play speed, but may cover a plurality of segments of videos with different play speeds, so that the generated video becomes more exciting and interesting.

In some examples, differing from the above embodiments, in another implementation solution, the control terminal detects the operation of controlling a video play speed, determines the video play speed as the first frame rate based on the operation of controlling a video play speed, and then sends, to the unmanned aerial vehicle, a video capturing instruction used to instruct the unmanned aerial vehicle to capture images at the preset frame rate. Correspondingly, after receiving the video capturing instruction sent by the control terminal, the unmanned aerial vehicle captures images according to the preset frame rate and sends the images captured according to the preset frame rate to the control terminal, then the control terminal generates a video with an accelerated play speed or a decelerated play speed according to the first frame rate and the images captured according to the preset frame rate that are sent by the unmanned aerial vehicle. As for the control terminal generating a video with an accelerated play speed or a decelerated play speed, a reference may be made to the above specific implementation process of the unmanned aerial vehicle generating a video with an accelerated play speed or a decelerated play speed, and will not be discussed herein.

Some exemplary embodiments of the present disclosure further provide a computer storage medium storing program instructions therein, and when the program is executed, part or all of the steps of the method of controlling a video play speed in the above embodiments may be included.

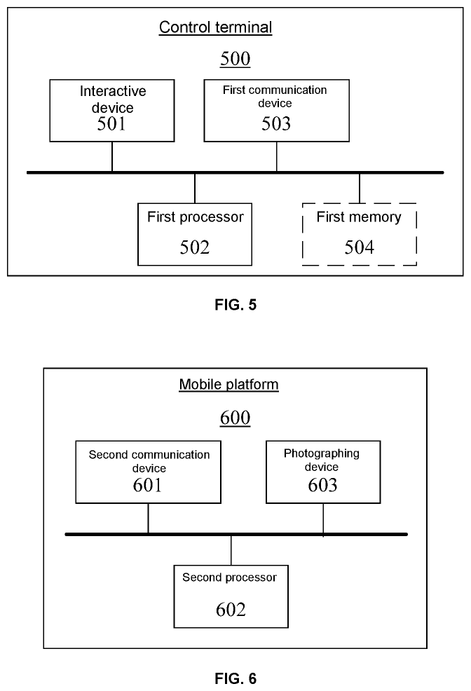

FIG. 5 is a schematic structural diagram of a control terminal provided by some exemplary embodiments of the present disclosure. As shown in FIG. 5, the control terminal 500 of this exemplary embodiment may be used to control a mobile platform. The control terminal 500 may include an interactive device 501, a first processor 502 and a first communication device 503. The interactive device 501, the first processor 502 and the first communication device 503 may be connected in communication via a bus. The first processor 502 may be a central processing unit (CPU), or may further be a general-purpose processor, a digital signal processor (DSP), an application specific integrated circuit (ASIC), a field-programmable gate array (FPGA), or another programmable logic device, a discrete gate or transistor logic device, a discrete hardware component and the like. The general-purpose processor may be a microprocessor or any conventional processor and the like. In some examples, the control terminal of this exemplary embodiment may further include a first memory 504 connected with the above components in communication via a bus.

The interactive device 501 may be configured to detect an operation of controlling a video play speed.

The first processor 502 may be configured to determine, according to the operation of controlling a video play speed, a video play speed as a first frame rate which is higher than or lower than a preset frame rate.

The first communication device 503 may be configured to send, to the mobile platform, a video capturing instruction to instruct the mobile platform to capture images according to the preset frame rate and generate a video with an accelerated play speed or a decelerated play speed according to the first frame rate.

In some examples, the first communication device 503 may be further configured to, after sending a video capturing instruction to the mobile platform, receive a video with an accelerated play speed or a decelerated play speed sent by the mobile platform, where the video is generated by the mobile platform according to the first frame rate.

In some examples, the first memory 504 is configured to store the video.

In some examples, the interactive device 501 is further configured to detect a sharing operation.

The first processor 502 may be further configured to share the video after the interactive device 501 detects the sharing operation.

In some examples, the interactive device 501 is further configured to detect a play operation. The first processor 502 is further configured to play the video after the interactive device 501 detects the play operation.

In some examples, the interactive device 501 is further configured to detect an operation of starting capturing a video before the first communication device 503 sends the video capturing instruction to the mobile platform. The first communication device 503 is specifically configured to send the video capturing instruction to the mobile platform when the interactive device 501 detects the operation of starting capturing a video.

In some examples, the interaction device 501 is further configured to detect an operation of pausing capturing a video during the process of capturing images according to the preset frame rate by the mobile platform. The first communication device 503 is further configured to send an instruction of pausing capturing a video to the mobile platform when the interactive device 501 detects the operation of pausing capturing a video, and the instruction of pausing capturing a video is used to instruct the mobile platform to pause capturing images.

In some examples, the first memory 504 is further configured to store program codes. When the program codes are executed, the control terminal 500 may implement the technical solution of the control terminal.

The control terminal of this exemplary embodiment may be used to carry out the technical solutions of the control terminal in the method embodiments of the present disclosure, and the implementation principles and technical effects are similar and thus will not be discussed herein.

FIG. 6 is a schematic structural diagram of a mobile platform provided by some exemplary embodiments of the present disclosure. As shown in FIG. 6, a mobile platform 600 of this exemplary embodiment may include a second communication device 601, a second processor 602, and a photographing device 603, and the second communication device 601, the second processor 602, and the photographing device 603 may be connected in communication via a bus. The second processor 602 may be a CPU, or may r be a general-purpose processor, a DSP, an ASIC, an FPGA or another programmable logic device, a discrete gate or transistor logic device, a discrete hardware component, or the like. The general-purpose processor may be a microprocessor or any conventional processor and the like.

The second communication device 601 is configured to receive a video capturing instruction sent by the control terminal of the mobile platform, the video capturing instruction instructs the mobile platform to capture images according to a preset frame rate and generate a video according to the first frame rate, and the first frame rate is lower than or higher than the preset frame rate.

The second processor 602 is configured to control the photographing device 603 to capture images at the preset frame rate, and generate a video with an accelerated play speed or a decelerated play speed according to the first frame rate.

In some examples, the second communication device 601 is further configured to send the video to the control terminal after the second processor 602 generates a video according to the first frame rate.

In some examples, the second processor 602 is specifically configured to: if the first frame rate is higher than the preset frame rate, frame-extraction process, according to the first frame rate, the images captured at the preset frame rate, and generate the video with an accelerated play speed from the images frame-extraction processed.

In some examples, the second processor 602 is specifically configured to: determine the size of a frame-extraction interval based on the first frame rate and the preset frame rate, the size of the frame-extraction interval representing extracting T frames at an interval of N frames, where N and T are integers greater than or equal to 1; and frame-extraction process the images captured at the preset frame rate according to the size of the frame-extraction interval.

In some examples, when a ratio of the first frame rate to the preset frame rate is greater than 2, T is greater than N; when a ratio of the first frame rate to the preset frame rate is equal to 2, T is equal to N; and when a ratio of the first frame rate to the preset frame rate is smaller than 2, T is lower than N.

In some examples, the second processor 602 is specifically configured to:

if the first frame rate is lower than the preset frame rate, extract M frames of images based on the first frame rate from the images captured at the preset frame rate, where M is an integer greater than or equal to 1; and according to the M frames of images, generate a video with a decelerated play speed.

In some examples, the second processor 602 is specifically configured to:

determine of the size of a frame-extraction interval based the first frame rate and the preset frame rate, the size of the frame-extraction interval indicating extracting K frames at an interval of Q frames, where Q and K are integers greater than or equal to 1; and extract M frames of images from the images captured at the preset frame rate with the mode of extracting K frames at an interval of Q frames of images.

In some examples, the second processor 602 is specifically configured to:

if the first frame rate is lower than the preset frame rate, control the photographing device 603 to collect M frames of images according to the first frame rate during the process of capturing images at the preset frame rate by the photographing device 603, where M is an integer greater than or equal to 1; and generate a video with a decelerated play speed according to the M frames of images.

In some examples, the second processor 602 is specifically configured to:

determine the number of collected frames according to the first frame rate and the preset frame rate, the number of collected frames indicating extracting K frames at an interval of Q frames, where Q and K are integers greater than or equal to 1; and control the photographing device 603 to collect K frames of images at an interval of Q frames to obtain M frames of images during the process of capturing images at the preset frame rate by the photographing device 603.

In some examples, when a ratio of the preset frame rate to the first frame rate is higher than 2, Q is greater than K; when a ratio of the preset frame rate to the first frame rate is equal to 2, Q is equal to K; and when a ratio of the preset frame rate to the first frame rate is lower than 2, Q is smaller than K.

In some examples, the second processor 602 is specifically configured to: copy and/or process every K frames of images in the M frames of images into Q+K frames of images; and

generate a video with a decelerated play speed from the images copied and processed.

In some examples, the second communication device 601 is further configured to receive the instruction of pausing capturing a video sent by the control terminal during the process of capturing images by the photographing device 603, the instruction of pausing capturing a video being determined by the control terminal upon detecting the operation of pausing capturing a video.

The second processor 602 is further configured to control the photographing device 603 to pause capturing images according to the instruction of pausing capturing a video.

In some examples, the mobile platform 600 of this exemplary embodiment may further include a second memory (not shown in the figures) used to store program codes. When the program codes are executed, the mobile platform 600 may implement the technical solution of the unmanned aerial vehicle.

The mobile platform of this exemplary embodiment may be used to implement the technical solutions of the unmanned aerial vehicle in the method embodiments of the present disclosure, and the implementation principles and technical effects are similar and thus will not be discussed herein.

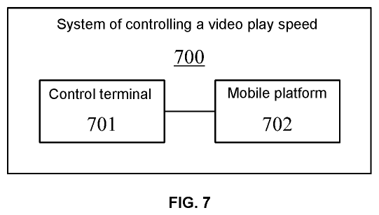

FIG. 7 is a schematic structural diagram of a system of controlling a video play speed provided by some exemplary embodiments of the present disclosure. As shown in FIG. 7, a system of controlling a video play speed 700 of this exemplary embodiment may include a control terminal 701 and a mobile platform 702, and the control terminal 701 and the mobile platform 702 may communicate through a wired communication link or a wireless communication link.

The control terminal 701 is configured to detect the operation of controlling a video play speed, according to the operation of controlling a video play speed, determine the video play speed as the first frame rate which is higher than or lower than a preset frame rate, and send, to the mobile platform 702, a video capturing instruction used to instruct the mobile platform 702 to capture images based on the preset frame rate and generate a video with an accelerated play speed or a decelerated play speed according to the preset frame rate. The mobile platform 702 is configured to receive the video capturing instruction sent by the control terminal 701, control the photographing device of the mobile platform 702 to capture images at the preset frame rate, and generate a video with an accelerated play speed or a decelerated play speed according to the first frame rate.

In some examples, the mobile platform 702 is further configured to send the video to the control terminal 701 after generating the video according to the first frame rate. The control terminal 701 is further configured to receive a video with an accelerated play speed or a decelerated play speed sent by the mobile platform 702 after sending the video capturing instruction to the mobile platform 702.

In some examples, the control terminal 701 is further configured to save the video.

In some examples, the control terminal 701 is further configured to share the video after detecting the sharing operation.

In some examples, the control terminal 701 is further configured to play the video after detecting the play operation.

In some examples, when generating the video according to the first frame rate, the mobile platform 702 is specifically configured to: if the first frame rate is higher than the preset frame rate, frame-extraction processing the images captured at the preset frame rate according to the first frame rate, and generate the video with an accelerated play speed from the images frame-extraction processed.

In some examples, when frame-extraction processing images captured at the preset frame rate according to the first frame rate, the mobile terminal 702 is specifically configured to: determine the size of a frame-extraction interval based on the first frame rate and the preset frame rate, the size of the frame-extraction interval representing extracting T frames at an interval of N frames, where N and T are integers greater than or equal to 1; and frame-extraction processing the images captured at the preset frame rate according to the size of the frame-extraction interval.

In some examples, when a ratio of the first frame rate to the preset frame rate is higher than 2, T is greater than N; when a ratio of the first frame rate to the preset frame rate is equal to 2, T is equal to N; and when a ratio of the first frame rate to the preset frame rate is smaller than 2, T is smaller than N.

In some examples, when generating the video according to the first frame rate, the mobile platform 702 is specifically configured to: if the first frame rate is lower than the preset frame rate, extract M frames of images according to the first frame rate from the images captured at the preset frame rate, where M is an integer greater than or equal to 1; and generate a video with a decelerated play speed based on the M frames of images.

In some examples, when extracting M frames of images according to the first frame rate from the images captured at the preset frame rate, the mobile platform 702 is specifically configured to: determine the size of a frame-extraction interval based on the first frame rate and the preset frame rate, the size of the frame-extraction interval representing extracting K frames at an interval of Q frames, where Q and K are integers higher than or equal to 1; and extract M frames of images from the images captured at the preset frame rate with the mode of extracting K frames at an interval of Q frames of images.

In some examples, when generating the video according to the first frame rate, the mobile platform 702 is specifically configured to: if the first frame rate is lower than the preset frame rate, control the photographing device to collect M frames of images according to the first frame rate during the process of capturing images at the preset frame rate by the photographing device of the mobile platform, where M is an integer greater than or equal to 1; and generate a video with a decelerated play speed according to the M frames of images.

In some examples, when controlling the photographing device to collect M frames of images based on the first frame rate during the process of capturing images at the preset frame rate by the photographing device of the mobile platform 702, the mobile terminal 702 is specifically configured to: determine the number of collected frames according to the first frame rate and the preset frame rate, the number of collected frames representing collecting K frames at an interval of Q frames, where Q and K are integers greater than or equal to 1; and control the photographing device to collect K frames of images at an interval of Q frames to obtain M frames of images during the process of capturing image at the preset frame rate by the photographing device of the mobile platform 702.

In some examples, when a ratio of the preset frame rate to the first frame rate is higher than 2, Q is greater than K; when a ratio of the preset frame rate to the first frame rate is equal to 2, Q is equal to K, and when a ratio of the preset frame rate to the first frame rate is lower than 2, Q is smaller than K.

In some examples, when generating a video with a decelerated play speed according to the M frames of images, the mobile platform 702 is specifically configured to: copy and/or process every K frames of images in the M frames of images into Q+K frames of images, and generate a video with a decelerated play speed from the images copied and processed.

In some examples, the control terminal 701 is further configured to detect the operation of starting capturing a video before sending the video capturing instruction to the mobile platform 702. Correspondingly, when sending the video capturing instruction to the mobile platform 702, the control terminal 701 is specifically configured to send the video capturing instruction to the mobile platform 702 upon detecting the operation of starting capturing a video.

In some examples, the control terminal 701 is further configured to: during the process of capturing images according to the preset frame rate by the mobile platform 702, detect the operation of pausing capturing a video; and after detecting the operation of pausing capturing a video, send, to the mobile terminal, the instruction of pausing capturing a video used to instruct the mobile platform 702 to pause capturing images.

The mobile platform 702 is further configured to: receive the instruction of pausing capturing a video sent by the control terminal 701 during the process of capturing images by the photographing device of the mobile platform 702, the instruction of pausing capturing a video being determined by detecting, by the control terminal 701, the operation of pausing capturing a video; and control the photographing device to pause capturing images according to the instruction of pausing capturing a video.

In summary, the system of controlling a video play speed provided by this exemplary embodiment may control the mobile platform to generate a video with a variable play speed during the capturing process of the mobile platform without post-processing the video to change the play speed thereof after the video is generated, thereby improving the efficiency of adjusting the video play speed and facilitating operations. In addition, the generated video may include a plurality of segments of videos with different play speeds, and thus becomes more exciting and interesting.

The control terminal 701 may adopt the structure of the embodiment shown in FIG. 5, correspondingly, the technical solutions of the control terminal of the method embodiments may be executed, and the implementation principles and technical effects are similar and thus will not be discussed herein. The mobile platform 702 may adopt the structure of the embodiment shown in FIG. 6, correspondingly, the technical solutions of the unmanned aerial vehicle in the method embodiments may be executed, and the implementation principles and technical effects are similar and will not be discussed herein.

Those having ordinary skills in the art may understand that all or part of the steps in the method embodiments may be implemented by means of hardware related to program instructions. The program may be stored in a computer readable storage medium, and when the program is executed, steps including the above method embodiments may be executed. The storage medium covers various media capable of storing program codes such as a read-only memory (ROM), a random access memory (RAM), a magnetic disk and an optical disk.

Finally, it should be noted that the above embodiments merely serve to illustrate the technical solution of the present disclosure rather than limit it. Although the present disclosure has been described in detail with reference to the above exemplary embodiments, those having ordinary skills in the art should understand the technical solutions stated in the above exemplary embodiments may be modified, or equivalent substitutions of part or all of the technical features therein may be made, and these modifications or substitutions will not deviate essence of the corresponding technical solutions from the scope of technical solutions of the embodiments of the present disclosure.

What is claimed is:

1. A method of controlling a video play speed by a control terminal, comprising:
detecting an operation of controlling a video play speed;
determining, based on the operation, a video play speed as a first frame rate higher than or lower than a preset frame rate; and
sending, to a mobile platform, a video capturing instruction to instruct the mobile platform to capture images based on the preset frame rate and generate a video with an accelerated play speed or a decelerated play speed based on the first frame rate.

2. The method according to claim 1, wherein, after the sending of the video capturing instruction, the method further comprises:
receiving the video with an accelerated play speed or a decelerated play speed sent by the mobile terminal, wherein the video is generated by the mobile terminal based on the first frame rate.

3. The method according to claim 2, further comprising:
sharing the video upon detecting a sharing operation.

4. The method according to claim 1, further comprising: prior to the sending of the video capturing instruction,
detecting an operation of starting capturing a video,
wherein the sending of the video capturing instruction includes sending, to the mobile platform, the video capturing instruction upon detecting the operation of starting capturing a video.

5. The method according to claim 1, further comprising:
detecting an operation of pausing capturing the video during capturing images by the mobile platform based on the preset frame rate; and
upon detecting the operation of pausing capturing a video, sending, to the mobile platform, an instruction of pausing capturing a video to instruct the mobile platform to pause capturing images.

6. A method of controlling a video play speed by a mobile platform, comprising:
receiving a video capturing instruction sent by a control terminal of the mobile platform to instruct the mobile platform to capture images based on a preset frame rate and to generate a video based on a first frame rate lower than or higher than the preset frame rate; and
controlling a photographing device of the mobile platform to capture images at the preset frame rate and to generate a video with an accelerated play speed or a decelerated play speed based on the first frame rate.

7. The method according to claim 6, further comprising, after the generating of the video based on the first frame rate,
sending the video to the control terminal; and
when the first frame rate is higher than the preset frame rate, the generating of the video according to the first frame rate includes:
conducting frame-extraction processing to the images captured at the preset frame rate based on the first frame rate, and
generating the video with an accelerated play speed with the images frame-extraction processed.

8. The method according to claim 7, wherein the performing of the frame-extraction processing to the images captured at the preset frame rate based on the first frame rate includes:
determining a size of a frame-extraction interval based on the first frame rate and the preset frame rate, the size of the frame-extraction interval indicating extracting T frames at an interval of N frames, wherein N and T are integers greater than or equal to 1; and
performing frame-extraction processing to the images captured at the preset frame rate based on the size of the frame-extraction interval.

9. The method according to claim 8, wherein:
when a ratio of the first frame rate to the preset frame rate is greater than 2, T is greater than N;
when a ratio of the first frame rate to the preset frame rate is equal to 2, T is equal to N; and
when a ratio of the first frame rate to the preset frame rate is smaller than 2, T is smaller than N.

10. The method according to claim 6, wherein, when the first frame rate is lower than the preset frame rate, the generating of the video based on the first frame includes:
extracting M frames of images from the images captured at the preset frame rate based on the first frame rate, wherein M is an integer greater than or equal to 1; and
generating a video with a decelerated play speed based on the M frames of images.

11. The method according to claim 10, wherein the extracting of the M frames of images from the images captured at the preset frame rate based on the first frame rate includes:
determining a size of a frame-extraction interval based on the first frame rate and the preset frame rate, the size of the frame-extraction interval representing extracting K frames at an interval of Q frames, wherein Q and K are integers greater than or equal to 1; and
extracting the M frames of images from the images captured at the preset frame rate by extracting K frames at an interval of Q frames of images.

12. The method according to claim 6, wherein, when the first frame rate is lower than the preset frame rate, the generating of the video based on the first frame rate includes:
controlling the photographing device to collect M frames of images based on the first frame rate during capturing images at the preset frame rate by the photographing device, wherein M is an integer greater than or equal to 1; and
generating a video with a decelerated play speed based on the M frames of images.

13. The method according to claim 12, wherein the controlling of the photographing device to collect the M frames of images based on the first frame rate during capturing images at the preset frame rate by the photographing device includes:
determining a number of collected frames based on the first frame rate and the preset frame rate, the number of collected frames representing collecting K frames at an interval of Q frames, wherein Q and K are integers greater than or equal to 1; and
controlling the photographing device to collect K frames of images at an interval of Q frames so as to obtain M frames of images during the process of capturing images at the preset frame rate by the photographing device of the mobile platform.

14. The method according to claim 10, wherein:
when a ratio of the preset frame rate to the first frame rate is greater than 2, Q is greater than K;
when a ratio of the preset frame rate to the first frame rate is equal to 2, Q is equal to K; and
when a ratio of the preset frame rate to the first frame rate is smaller than 2, Q is lower than K.

15. The method according to claim 11, wherein the generating a video with a decelerated play speed based on the M frames of images includes:
copying every K frames of images from the M frames of images to obtain Q+K frames of images; and
generating a video with a decelerated play speed from the images copied and processed.

16. The method according to claim 6, further comprising:
during capturing images by the photographing device of the mobile platform, receiving, from the control terminal, an instruction of pausing capturing a video, wherein the instruction is determined upon detecting an operation of pausing capturing a video by the control terminal; and
controlling the photographing device to pause capturing images according to the instruction.

17. A control terminal, comprising:
an interactive device to detect an operation of controlling a video play speed;
a first processor to determine, based on the operation of controlling a video play speed, a video play speed as a first frame rate, wherein the first frame rate is higher than or lower than a preset frame rate; and
a first communication device to send a video capturing instruction to a mobile terminal to instruct the mobile platform to capture images based on the preset frame rate and to generate a video with an accelerated play speed or a decelerated play speed based on the first frame rate.

18. The control terminal according to claim 20, wherein the first communication device is further configured to, after sending the video capturing instruction to the mobile terminal, receive the video with an accelerated play speed or a decelerated play speed sent by the mobile terminal, and
the video is generated by the mobile platform based on the first frame rate.

19. The control terminal according to claim 18, wherein:
the interactive device is further configured to detect a sharing operation; and
the first processor is further configured to share the video after the interactive device detects the sharing operation.

20. The control terminal according to claim 18, wherein:
the interactive device is further configured to detect a play operation; and
the first processor is further configured to play the video after the interactive device detects the play operation.
